(19) United States
(12) Patent Application Publication
(10) Pub. No.: US 2008/0072507 A1
(43) Pub. Date: Mar. 27, 2008

(54) Jamb and casement system

(76) Inventors: Morgan Hsi-Jung Chuang, Cypress, CA (US); David Pon, Tustin, CA (US)

Correspondence Address: BUCHANAN INGERSOLL & ROONEY PC, P.O. BOX 1404, ALEXANDRIA, VA, 22313-1404, US

(21) Appl. No.: 11/825,180

(22) Filed: Jul. 5, 2007

Related U.S. Application Data
(60) Provisional application No. 60/846,556, filed on Sep. 22, 2006.

(51) Int. Cl. E06B 3/26; E04F 10/08; E06B 9/06; G05B 15/00

(52) U.S. Cl. 52/204.5; 160/19; 160/38; 700/1

(57) ABSTRACT

A jamb and casement system for a window opening defined by a window opening frame is disclosed. The jamb and casement system has a jamb that is sized and configured to fit within the window opening. The jamb has a first side, an opposite second side, a front face extending between the first side and the second side and a rear face extending between the first side and the second side. A casement is connected to the first side of the jamb. An inner covering trim is also provided. A portion of the inner covering trim overlays a portion of the front face of the jamb and extends beyond the front face of the jamb adjacent the second side of the jamb.

### CROSS-REFERENCE TO RELATED APPLICATION

The present application claims the benefit under 35 U.S.C. § 119(e) of pending U.S. Provisional Patent Application Ser. No. 60/846,556 which was filed on Sep. 22, 2006.

### FIELD OF INVENTION

The present invention relates to an interior window framing system.

### BACKGROUND OF THE INVENTION

Window openings are typically designed and constructed for buildings and homes to allow natural light to enter into the building, ventilate interior spaces, and provide a view of the area outside the window. When a building is being constructed, walls are normally defined by wooden frames. The wooden frames of outside walls usually include a window frame portion that defines a window opening. After a window is installed in an opening, drywall panels or other wall panels are attached to the interior face of the wall frame surrounding the window.

When drywall or other panels are installed around a window opening, the panels are cut to avoid covering the window opening. It is desirable to create perfectly straight and smooth edges along the window opening that form perfectly square corners. However, cutting drywall in this fashion is very difficult. Moreover, the cut edges of the drywall as well as other types of paneling may crack, chip, or crumble unless they are sealed or protected. To solve this problem various methods of sealing or protecting the edges of drywall have been developed.

For example, drywall tape and drywall joint compound, or plaster, are often used to cover drywall edges. Some methods typically used to apply the tape and plaster are discussed in U.S. Pat. No. 6,936,645 to Hessler. Other methods of sealing and protecting drywall edges, some of which include the use of metal corner beads and plaster, are disclosed in U.S. Pat. No. 5,531,050 to Stibolt et al. Most drywall edge finishing methods currently practiced require the use of plaster or joint compound to cover the edge created by tape or metal corners attached to the drywall edge. When the joint compound or plaster is applied, it is smoothed along the edges of the tape or metal corner in an attempt to conceal any depressions that may exist along the drywall and to seal the drywall edge. Because of the significant amount of skill required to create a smooth and straight drywall edge and the variation in skill level among workers, window openings created in this way are typically not uniform. Such window openings usually have irregular edge or corner surfaces along the interior wall. Moreover, such window openings are often out of square with the window that is later installed in the opening.

It is quite common to replace older windows with new windows of a different type or style. The window opening in which the replacement window is placed may have a drywall portion adjacent and interior to the window. Quite often installers of replacement windows will have difficulty centering the window on the window opening so that the same amount of the portion of the window between the glass and the adjacent drywall is exposed on all sides. Customers have complained when the replacement window does not appear to be centered. A related problem occurs if the drywall is uneven along the length of the window. Such unevenness results in different portions of the window adjacent the glass being exposed. Consequently, there is a need for a product that assures the window will be or will appear to be centered in the window opening.

The irregular, and often poorly finished, edges abutting the window opening are usually covered with a decorative interior frame that provides a desired aesthetic effect. Because window openings vary in size and shape, decorative interior window frames typically must be customized to appropriately fit the window openings. Unfortunately, such customization often does not square the frame to the window opening, which can detract from the desired aesthetic effect of the frame. Moreover, the inability of builders to create window openings of standard dimensions has made creating mass produced interior decorative window frames uneconomical.

Home centers and other retailers sell several types of window coverings which they keep in stock at each retail location. These window coverings, called stock blinds, come in several standard widths selected to correspond to the openings of the most popular window sizes. In a stock blind program the homeowner measures the window opening and brings that measurement to the retail store. A sales associate selects the size of stock blind which is closest to those measurements and often must trim and shorten the blind to correspond to the dimensions provided by the customer. The customer then takes the cut-down blind home and mounts it on the window frame. Some window coverings are custom made and installed by professionals. In those circumstances an installer comes to the home, measures the windows and orders the blinds. Several days or weeks later, after the custom blinds have been made, the installer returns to the home and installs the blinds. Stock blinds have been very popular because the buyer can purchase and install them on the same day. Furthermore, stock blinds tend to be less expensive. Whether the customer buys a stock blind or a custom blind either the customer or the installer must measure the window opening before ordering the blind. Consequently, it is not possible to order window coverings prior to or during the early stages of building construction. Only after the windows have been installed and the window openings have been finished can the measurements be taken and the window coverings ordered.

Whether window openings are measured by the homeowner or by a professional, there is a potential for error. Many homeowners fear that the measurements they make will be incorrect. When a window opening is measured incorrectly, the blind which has been custom made or the cut down stock blind for that opening will not fit the window opening. That blind must be returned to the store or fabricator and be replaced or cut down to the proper size. This results in additional expense to the seller as well as delay in installation.

Thus, there is a need for a system that will assure correct measurements are made, thereby eliminating the situation where products are sized incorrectly and an installer or homeowner attempts to install a window covering that does not fit the window opening. Preferably, the system will assure that certain stock sizes of window coverings will fit the window openings. Then, there would be no need for measurements to be made by the customer or installer and no need to cut down stock size window coverings.

Prince et al. disclose an interior framing system that attempts to alleviate some of the above mentioned problems in U.S. Pat. App. No. 2006/0037260. Prince et al. teach a framing system comprised of a jamb portion and a casement portion that is leveled and squared with the window and does not require direct contact with the window frame. This framing system attaches a jamb portion of the framing system to the casement portion by interlocking edges on the jamb portion with corresponding grooves in the casement portion. The jamb will abut the window only if the width of the window frame is equal to or somewhat less than the width of the jamb and tongue which fits in the groove in the casement. While the depth of the insertion of the tongue into the groove can vary the size somewhat, the extent of the variance is limited. There is often a visible gap between the jamb portion of this interior framing system and the window. Prince et al. teach that this gap may be filled with foam, rubber, plastic, wood, or other materials. However, use of such materials fails to provide an appearance that is consistent with the rest of the decorative interior frame. As a result, these spacers devalue the frame by detracting from the aesthetic effect of the jamb. The appearance of such decorative frames is similarly affected if the gap is left unfilled. Moreover, the insulation properties of the interior frame are negatively affected by any unfilled gap because heat transfers more easily through the unfilled and unsightly gap portions of this framing system. This framing system disclosed by Prince et al is also difficult to use for arched windows.

Thus, a device is still needed to standardize the window opening for installation of an interior window frame that requires substantially less installation work and provides an interior window frame that is square with the installed window and has a decorative trim along the entire window opening. Such a device should also provide an interior frame with known dimensions. Preferably, these known dimensions correlate with a stock size of a window covering.

### SUMMARY OF THE INVENTION

We provide a jamb and casement system for a window opening defined by a window opening frame. The system has a jamb that is sized and configured to fit within the window opening. The jamb has a first side, an opposite second side, a front face extending between the first side and the second side and a rear face extending between the first side and the second side. A casement is attached to the first side of the jamb. An inner covering trim is also provided. A portion of the inner covering trim overlays a portion of the front face of the jamb. The inner covering trim extends beyond the front face of the jamb adjacent the second side of the jamb.

The casement can be connected to the first side of the jamb by at least one tongue and groove joint. One or more shims may be positioned adjacent the jamb.

In some embodiments, the inner covering trim can be a unitary structure. The inner covering trim, jamb, or casement can be made of wood, plastics or composite materials and could have a foam core in a plastic shell. At least one tab can be attached to the inner covering trim that extends over at least a portion of the second side of the jamb.

Insulation, foam, or filler material may be positioned adjacent at least a portion of the second side of the jamb.

We may provide one or more flanges extending from the jamb or casement. A shutter, valance, blind, or other window covering can be connected to the flange.

The casement may have at least one cavity and at least one removable cap that covers the at least one cavity. These removable caps preferably cover cavities in the casement that are sized to house a portion of the fastener or fasteners used to attach the casement to the wall or window frame.

At least one resilient member can abut the first side or second side of the jamb. This resilient member can be made of various resilient materials, such as elastics, rubber, plastics or foams.

We prefer to provide a vapor barrier wherein at least a portion of the vapor barrier is attached to the inner covering trim. The vapor barrier can prevent moisture that may condense on a window from migrating into the inner covering trim from the window. Preferably, the vapor barrier is made of a moisture proof material such as cellophane, or other foams or plastics.

A light block may be attached to the jamb. In alternative embodiments, a hang strip can be attached to the jamb. At least one hinge may be attached to the hang strips. In some embodiments, each hinge is attached to a different hang strip.

In some embodiments, hinges can be connected to the jamb or the casement. A shutter can be attached to the hinges.

We also provide a method of selling window coverings that includes offering at least one jamb and casement system, allowing a customer to select at least one jamb and casement system from among those offered, offering the customer a selection of window covering products sized to fit the opening in the jamb and casement system selected by the customer, allowing the customer to select a window covering product from among the selection of window covering products, and delivering the selected window covering product or products and jamb and casement system or systems to the customer. Such delivery could be to the purchaser or to a builder or installer selected by the purchaser.

The customer is not limited to the home owner or building owner, but could be a tenant, builder, modular building or modular home manufacturer, real estate developer, architect, engineer, or other contractor.

The selection of window covering products preferably includes shutters, venetian blinds, roman shades, cellular shades, pleated shades, roller shades, rollup shades, and vertical blinds.

In some embodiments, the method of selling window coverings can also include displaying a sample of at least one of the jamb and casement system and the selection of window covering products. In other embodiments, the method of selling window coverings further includes providing installation instructions for the jamb and casement system and the selection of window covering products.

Other details, objects, and advantages of the invention will become apparent as the following description of certain present preferred embodiments thereof and certain present preferred methods of practicing the same proceeds.

### BRIEF DESCRIPTION OF THE DRAWINGS

In the accompanying drawings we have shown certain present preferred embodiments of our jamb and casement system in which:

FIG. 1 is a perspective view of a window opening in a wall.

FIG. 2 is a perspective view of a first present preferred embodiment of our invention.

FIG. 3 is a perspective view of the first present preferred embodiment installed in a window opening.

FIG. 4 is a sectional view taken along the line IV-IV in FIG. 3.

FIG. 5 is a sectional view similar to FIG. 4 showing a second present preferred embodiment.

FIG. 6 is a front view of the second present preferred embodiment to which a venetian blind has been attached.

FIG. 7 is front view similar to FIG. 6 showing the blind in a fully raised position.

FIG. 8 is a sectional view of a portion of a third present preferred embodiment.

FIG. 9 is a perspective view of a portion of a differently shaped casement that could be used in the third present preferred embodiment shown in FIG. 8.

FIG. 10 is a perspective view of the jamb shown in FIG. 8 with which yet another casement is used.

FIG. 11 is a sectional view similar to FIGS. 4 and 5 of a fourth present preferred embodiment.

FIG. 12 is a sectional view similar to FIGS. 4, 5 and 11 of a fifth present preferred embodiment.

FIG. 13 is a sectional view of a sixth present preferred embodiment of our jamb and casement system showing a portion of a shutter attached.

FIG. 14 is a sectional view of a seventh present preferred embodiment showing a portion of a shutter attached.

### DETAILED DESCRIPTION OF THE PRESENT PREFERRED EMBODIMENTS

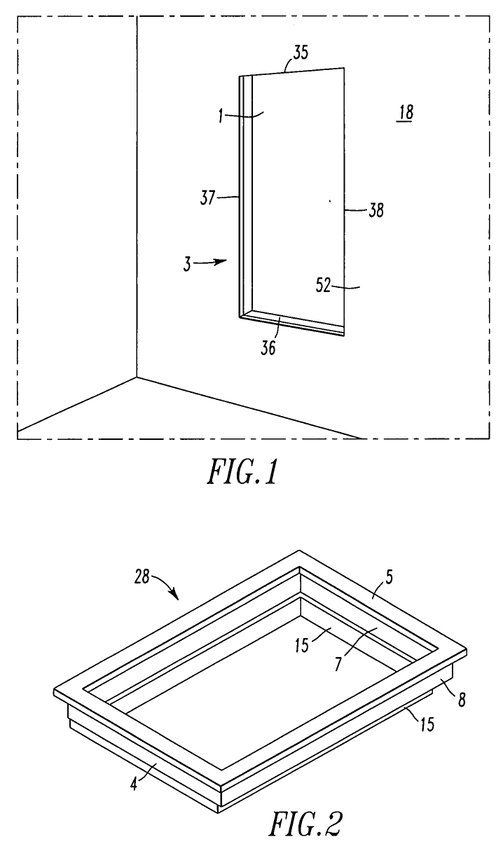

Referring to FIG. 1, wall 18 has a window opening 1 defined by window opening frame 3. The window opening frame has vertical sides 37, 38 and a horizontal bottom 36 and horizontal top 35. The window frame is typically made of wooden boards, such as 2″ by 4″ (5.08 cm by 10.16 cm) boards. Drywall or other paneling 52 is installed on the interior of the frame of the wall, defining the interior surface of wall 18, and surrounds the window opening 1.

A first present preferred embodiment of our invention is shown in FIG. 2. The frame 28 of the first present preferred embodiment defines an opening having a known width and height and square corners. The frame 28 has a jamb 4 that has a front face 7 and a rear face 8. A casement 5 is connected to the jamb 4 adjacent the first side of the jamb. An inner covering trim 15 is adjacent the opposite, second side of the jamb 4. A portion of the inner covering trim 15 overlays a portion of the front face of the jamb. As a result, the inner covering trim 15, as well as a portion of the jamb 4, are visible through the opening in the middle of the frame 28.

The jamb 4, casement 5 and the inner covering trim 15 may be made of composite materials, wood or plastic. They could also be made of a plastic shell filled with a foam core. Such a shell and core structure is shown in FIG. 8, which illustrates a portion of the jamb 4 having a shell 80 and an inner foam core 81 in dotted lines. The shell could be vinyl or acrylic styrene acrylonitrile (ASA) and the core could be polyurethane or styrene. The inner covering trim 15, as well as the jamb 4 and casement 5 combination, may each be formed as a unitary structure. This structure may be rectangular in shape, or may be shaped for square, circular, oval, semicircular or other non-rectangular shaped windows. Indeed, making non-rectangular shaped units as unitary structures can provide easier installation at the job site.

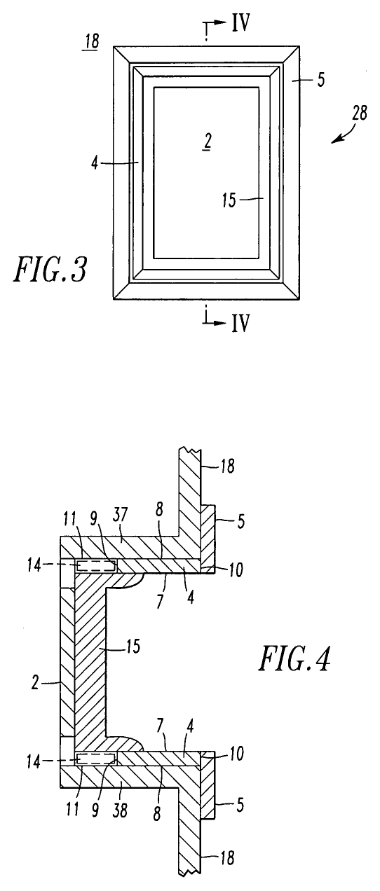

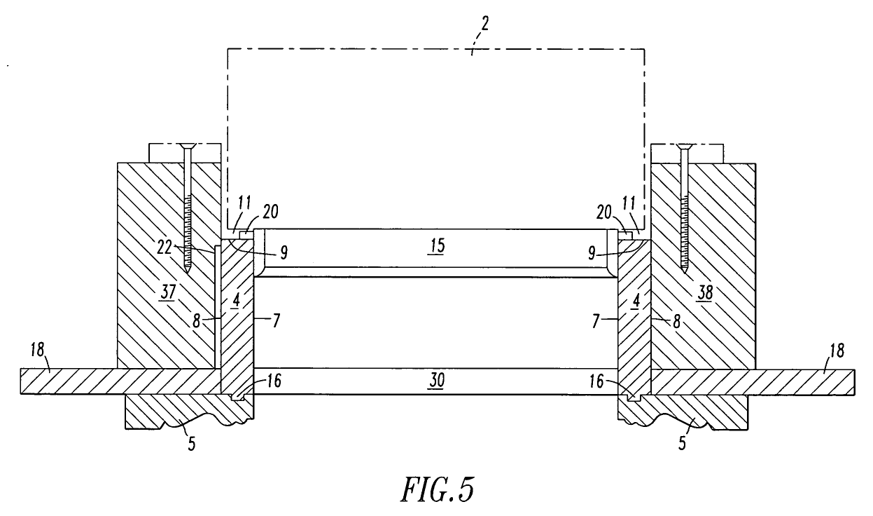

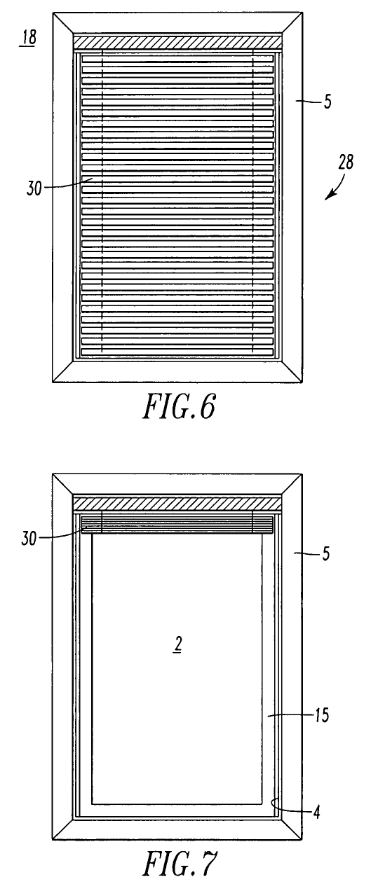

When the frame is installed in a window opening, as shown in FIGS. 3, 4, 5, 6, 7, 11, 12, 13 and 14, the jamb 4 covers a portion of the top 35, bottom 36, and each side 37, 38 of the window opening frame. The front face 7 of the jamb faces into the window opening while the rear face 8 of the jamb faces the window opening frame. The first side 10 of the jamb is connected to the proximate side 12 of the casement 5, as shown in FIG. 4. A tongue and groove joint 16 is preferably used to interlock the jamb 4 with the casement 5 as shown in FIG. 5. Because the width of the jamb 4 is less than the width of the window opening frame 3, a gap 11 is formed between the second side 9 of the jamb portion and the window 2.

The inner covering trim 15 is adjacent the second side 9 of the jamb. A portion of the inner covering trim 15 overlays a portion of the front face 7 of the jamb and extends beyond the front face 7 of the jamb adjacent the second side 9, covering the gap 11 between the jamb 4 and the window 2. The inner covering trim can be formed of four boards joined together with a tongue and groove joint or a butt joint.

While a tongue and groove joint is disclosed as a present preferred embodiment for connecting the jamb 4 to the casement 5 or inner covering trim 15, it should be understood that other forms of attachment, such as brackets, adhesives, or fasteners may be used.

The present invention is intended to be primarily installed by a builder during construction or remodeling shortly after drywall or paneling has been applied to the interior walls and the windows are in place. The dimensions of the window opening will be specified in the construction drawings. Consequently, the builder may order finished jamb and casement systems similar to that shown in FIG. 2 for each window opening. The systems would be packaged such that the inner trim 15 is not connected to the frame formed by the assembled jamb 4 and casement 5. After the drywall or paneling has been installed a carpenter positions the jamb 4 within the opening and may provide shims 22 between the jamb 4 and the sides of the window opening. Then the jamb 4 is attached to the window opening by screws or nails. Next, the inner covering trim 15 is placed within the window opening 1 adjacent the second side 9 of the jamb portion such that a portion of the inner covering trim 15 overlays a portion of the front face 7 of the jamb. The inner covering trim extends beyond the jamb 4 adjacent the second side 9 of the jamb such that the inner covering trim abuts the window 2, covering gap 11. Once positioned within the window opening frame 3, the inner covering trim 15 can be held in place by screws, nails, or an adhesive.

In an alternate embodiment shown in FIG. 5, tabs 20 extend from the inner covering trim 15 such that at least a portion of the tab extends over the second side 9 of the jamb. This embodiment is installed by first placing the inner covering trim 15 in the window opening and then installing the jamb 4 and casement 5 portions. During installation of the jamb and casement, a portion of the jamb is fitted over the sides of the window opening. The inner covering trim will cover any gap between the jamb and the window.

The inner covering trim is maintained in position by the tight fit the inner covering trim 15 has with the jamb 4 and the window 2. The jamb 4 should be attached to the top 35, bottom 36, and sides 37, 38 of the window opening frame 3 by nails or screws. The casement 5 may be attached to the sides of the window opening frame or other parts of the wall 18 adjacent the window opening by screws, nails, adhesives or other mounting devices.

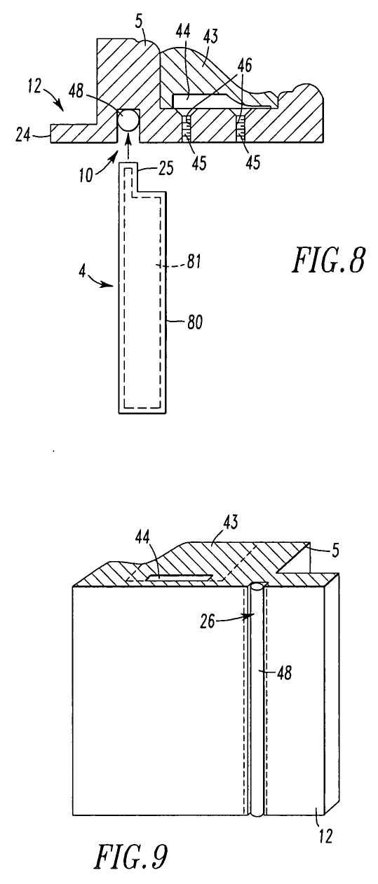

Fasteners can detract from the aesthetic effect of the casement. Thus, it is often desirable to conceal the fasteners from view. We prefer to provide removable caps 43 to cover the locations at which the fasteners are placed to attach the casement 5 to the adjacent wall 18 or window opening frame 3, as best seen in FIGS. 8 and 9. These caps 43 cover cavities 44 within the casement 5. The cavities are sized to permit the head of a nail, screw 45 or other fastener to be covered by the cap 43. These caps are removed by an installer to attach the fasteners and are subsequently reattached to conceal the fasteners. Pre-drilled screw holes 46 in the casement 5 can extend from the cavities 43.

If desired one can provide resilient members 48 in the tongue and groove joints to ensure that the jamb portion 4 of the frame 28 tightly fits within the casement 5 as shown in FIGS. 8 and 9. The resilient members 48 could also be used to enable the jamb and casement to move relative to one another and provide a tighter fit between the jamb and tabs on the inner covering trim. The resilient members are preferably made of an elastic material, such as rubber, but can be made of plastics, foams and other compressible or flexible materials as well.

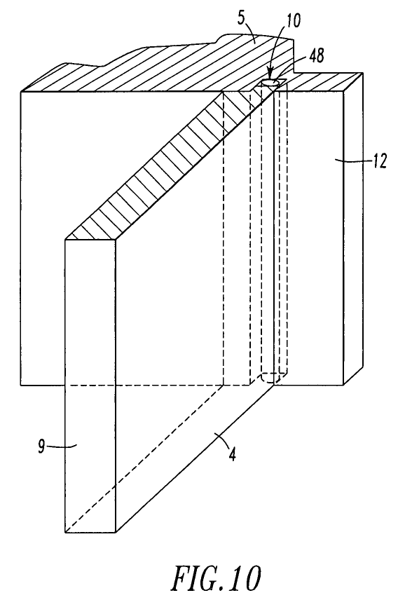

We prefer to use resilient members 48 located within grooves 26 in the casement 5, as shown in FIGS. 8, 9, and 10. The grooves 26 are configured to mate with the tongues 25 on the first side 10 of the jamb. The tongues 25 are placed in contact with the resilient member 48 inside the groove, forcing the resilient member to contract. The contracted resilient member will then exert a force against the jamb, keeping the jamb in a close fit with the inner covering trim 15 and the casement 5. Of course, it should be understood that alternative embodiments may have the groove portion of the tongue and groove joint in the jamb and the tongue portion of the joint in the casement.

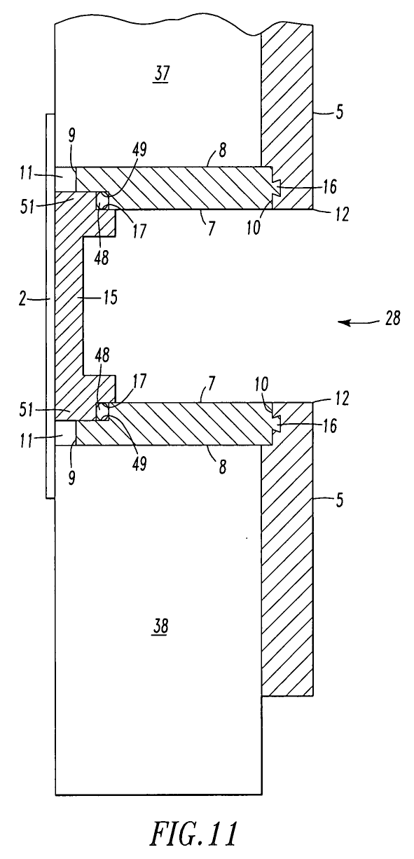

Another present preferred embodiment is shown in FIG. 11. In this embodiment a notch 49 is cut in the front face 7 of the jamb, near the second side 9 of the jamb. A corresponding notch 17 is cut in the inner trim covering 15 such that a portion 51 of the inner covering trim 15 fits within notch 49. If desired, a resilient member 48 can be provided in the notch 49. The resilient member 48 can push the inner covering trim 15 against the window 2 to help ensure the inner covering trim 15 is tightly fitted against the window. We prefer to insert filler, foam or insulation 14 into the gap 11.

Flanges 24 may extend from the front face 7 of the jamb or the proximate side 12 of the casement 5 as shown in FIG. 8. The flanges are particularly useful for mounting shutters to the frame. However, other window coverings 31, such as cellular shades, venetian blinds 30, roman shades, pleated shades, roller shades, rollup shades, and vertical blinds can be connected to the flanges. The flanges may be hinges, brackets, and other mounting devices that are used to mount window coverings.

Because the frame 28 standardizes the dimensions to the window opening 1, a stock blind sized to the standard dimensions of the frame 28 could be attached to the flanges 24. A builder that orders a jamb and casement system can at the same time order window covering products from a selection of such products offered to the builder that are sized to fit the opening of the jamb and casement system. Such window covering products can have flanges attached to the product for mounting the product to the jamb and casement system or can be configured so that the product can be fit or mounted on a flange attached to or installed on the jamb and casement system.

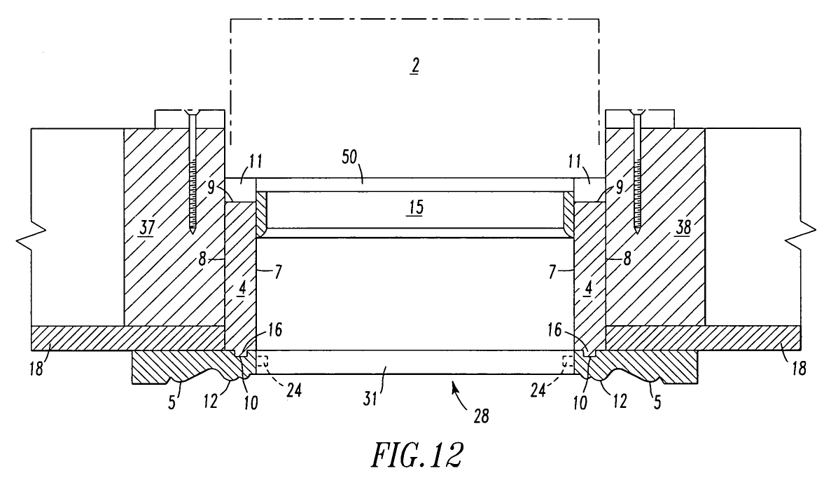

Condensation may occur on the window 2. For that reason, we prefer to provide a vapor barrier 50 shown in FIG. 12 between the inner covering trim 15 and the window 2 to prevent condensation damage. Preferably, the vapor barrier 50 is made of a material that is moisture proof, such as cellophane. The moisture proof material should prevent any condensation that may form on the window from migrating into the inner covering trim. The vapor barrier can also be made of other materials such as plastic or foam.

The jamb and casement frame 28 creates the appearance of a uniform window casing that covers the window opening 1 and portions of the adjacent wall 18. Because the frame 28 covers the edges between the window opening and the wall, drywall cornering methods for finishing the window opening are, for the most part, unnecessary. Consequently, the present invention reduces the time necessary for finishing the walls adjacent such window openings.

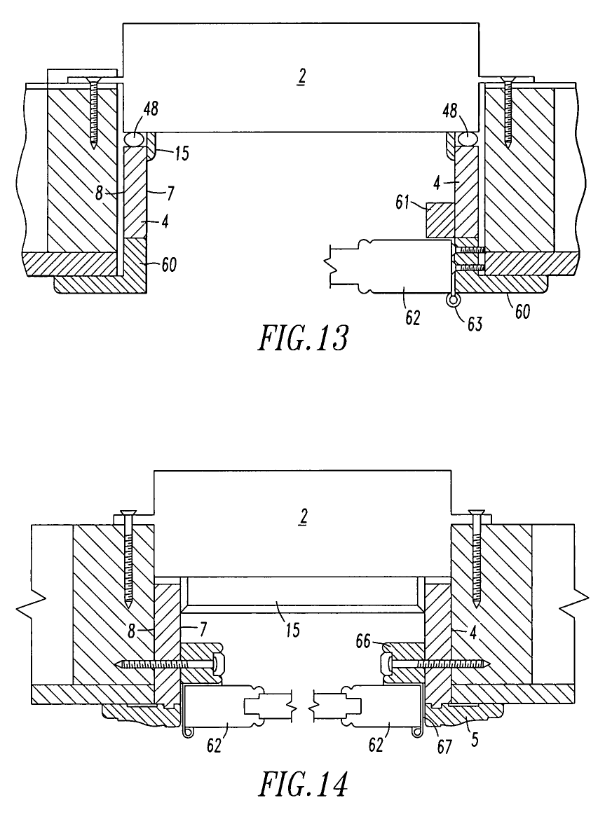

In the embodiment of FIG. 13 an L-shaped casement 60 is provided so that a shutter 62 may be attached to a solid structure. If a shutter was attached to the jamb and casement system shown in FIG. 4, 5, 11 or 12 the screws for the shutter hinge 63 could be aligned with the joint between the jamb 4 and casement 5. Any screw driven into that joint may split the wood and could come loose easily.

In the seventh embodiment shown in FIG. 14 a hang strip 66 is connected to opposite portions of the jamb 4 to provide a mount for the shutter hinges. L-shaped hinges 67 are used to attached the shutters 62 to the hang strip 66. The hang strip also functions as a light block that stops light from passing between the jamb and the shutter. In alternative embodiments, we provide a light block 61 connected to the jamb 4 adjacent the shutter, as shown in FIG. 13. The light block may have a rectangular cross-section as shown, or the cross section could be half-round or another decorative shape.

While the illustrated embodiments illustrate jamb and casements having a rectangular shape, that shape is not essential. Window openings of any shape and size, including but not limited to rectangular, arched and circular window openings, may also be framed by embodiments of our invention. Consequently, at least one segment of the jamb could be curved or angled and a portion of the casement 5 or inner covering trim 15 can be angled or curved. The important consideration is that the jamb 4 and inner covering trim 15 be configured to fit within the window opening 1. Our invention can be used in large window opening frames that use the floor of a room as the horizontal bottom portion of the frame.

All of the embodiments here disclosed have frames 28 in which the dimensions of the opening defined by the frame is known and the opening is square. As a result one can easily install a window covering within the frame. One popular window covering is a venetian blind 30 shown in FIGS. 5, 6 and 7. This blind is mounted on the frame using conventional mounting hardware. Since the opening defined by the frame is known and the opening is square, the blind need not be installed by a professional. A homeowner could purchase a standard size blind sized for the opening and install it himself without making any measurements. Because stock blinds would be available to fit the pre-made frames, a consumer can avoid the common practice of having a stock blind cut to fit the particular dimensions of the consumer's window opening. All the problems that can arise from the consumer or installer measuring the opening are avoided.

Another advantage is that a builder could allow his customer to order window coverings during construction of their house or office building. The customer could then include the cost of window treatments in his mortgage.

Although we envision the primary use of our jamb and casement system to be in new construction, the product can also be installed when a window is replaced. Use of this system can overcome the centering problem associated with replacing windows in openings having drywall which abuts the inside surface of the window. Through the use of shims where required, the jamb and casement system can be replaced adjacent the window so that the exposed portion of the window adjacent the glass is the same along all edge of the window.

We also provide a method of selling window coverings that includes offering at least one jamb and casement system and allowing a customer, such as a builder, to select at least one of the jamb and casement systems from among the offered systems. The customer may then be offered a selection of window covering products sized to fit the opening in the selected jamb and casement systems. The customer may be allowed to select at least one of the offered window covering products. The selected jamb and casement systems and window covering products may then be delivered to the customer.

The jamb and casement systems and window covering products may be delivered separately or at the same time. Installation instructions should be provided with the delivered goods. In some embodiments, the jamb and casement system may be packaged with the window covering product such that the window covering product and jamb and casement system are delivered at the same time. In other embodiments, the jamb and casement system and window covering products may be installed after the goods were delivered. Such installation can be performed such that the customer does not have to install the jamb and casement system or the window covering products.

Of course, samples of the window covering products and jamb and casement systems may be displayed before, after, or at the time the system or products are offered to a customer. The display of samples may take place in a retail establishment, at trade shows, in television advertisements, on the internet by pictures, drawings, or movies viewable from a website, or by other advertisement and display methods known to those skilled in the art. The samples may be displayed such that the window covering products are mounted on the jamb and casement system. Of course, the window covering products and jamb and casement system samples may also be displayed separately. The window covering products may be shutters, venetian blinds, roman shades, cellular shades, pleated shade, roller shades, rollup shades, or vertical blinds.

While we have shown and described certain present preferred embodiments of our jamb and casement system and have illustrated certain present preferred methods of making, installing and selling the same, it is to be distinctly understood that the invention is not limited thereto but may be otherwise variously embodied and practiced within the scope of the following claims.

We claim:

1. A jamb and casement system for a window opening defined by a window opening frame and into which opening a window is installed comprising:
a jamb sized and configured to fit within the window opening, the jamb having a first side, an opposite second side, a front face extending between the first side and the second side and a rear face extending between the first side and the second side;
a casement connected to the first side of the jamb; and
an inner covering trim, a portion of the inner covering trim overlaying a portion of the front face of the jamb, the inner covering trim extending beyond the front face of the jamb adjacent the second side of the jamb.

2. The jamb and casement system of claim 1 further comprising at least one material selected from the group consisting of insulation, foam, and filler positioned adjacent at least a portion of the second side of the jamb.

3. The jamb and casement system of claim 1 also comprising at least one tab attached to the inner covering trim, and extending over at least a portion of the second side of the jamb.

4. The jamb and casement system of claim 1 further comprising at least one shim positioned adjacent to the jamb.

5. The jamb and casement system of claim 1 wherein the casement is connected to the jamb by at least one tongue and groove joint.

6. The jamb and casement system of claim 1 further comprising at least one flange extending from one of the jamb and the casement.

7. The jamb and casement system of claim 6 further comprising a window covering connected to the at least one flange.

8. The jamb and casement system of claim 7 wherein the window covering is selected from the group consisting of shutters, venetian blinds, roman shades, cellular shades, pleated shades, roller shades, rollup shades and vertical blinds.

9. The jamb and casement system of claim 1 wherein at least one of the jamb, the casement, the inner covering trim and a combination of the jamb and the casement is a unitary structure.

10. The jamb and casement system of claim 1 further comprising at least one resilient member abutting one of the second side of the jamb and the first side of the jamb.

11. The jamb and casement system of claim 10 wherein the resilient member is comprised of a material selected from the group consisting of rubber, elastics, plastics and foams.

12. The jamb and casement system of claim 1 wherein the casement has at least one cavity, the jamb and casement system further comprising at least one removable cap attached to the casement, the at least one removable cap covering the at least one cavity.

13. The jamb and casement system of claim 1 further comprising a vapor barrier, at least a portion of the vapor barrier being attached to the inner covering trim.

14. The jamb and casement system of claim 13 wherein the vapor barrier is comprised of a material selected from the group consisting of cellophane, foam and plastics.

15. The jamb and casement system of claim 1 wherein at least one of the jamb, the casement, and the inner covering trim is comprised of at least one material selected from the group consisting of wood, plastics and composite materials.

16. The jamb and casement system of claim 1 wherein the jamb and casement form a frame having a shape selected from the group consisting of rectangular, square, circular, oval and semicircular.

17. The jamb and casement system of claim 1 further comprising at least one light block attached to the jamb.

18. The jamb and casement system of claim 1 further comprising at least one hang strip attached to the jamb.

19. The jamb and casement system of claim 18 further comprising at least one hinge, attached to the at least one hang strip.

20. The jamb and casement system of claim 1 further comprising at least one hinge connected to at least one of the jamb and the casement.

21. The jamb and casement system of claim 20 further comprising a shutter attached to the at least one hinge.

22. The jamb and casement system of claim 1 wherein at least one of the jamb, the casement, and the inner covering trim has a plastic shell and a foam core within the plastic shell.

23. A method of selling window coverings comprising:
offering at least one jamb and casement system defining an opening with known dimensions;
allowing a customer to select at least one jamb and casement system from among the at least one jamb and casement system;
offering the customer a selection of window covering products sized to fit the opening in the at least one jamb and casement system selected by the customer;
allowing the customer to select at least one window covering product from among the selection of window covering products offered to the customer; and
delivering the selected at least one window covering product and the at least one jamb and casement system to the customer.

24. The method of claim 23 wherein the customer is a builder.

25. The method of claim 23 further comprising displaying a sample of at least one of the at least one jamb and casement system and at least one window covering product of the selection of window covering products.

26. The method of claim 25 wherein the at least one window covering product of the selection of window covering products is displayed such that that window covering product of the selection of window covering products is connected to one of the at least one jamb and casement system.

27. The method of claim 23 further comprising providing installation instructions for at least one of the jamb and casement system and the selection of window covering products.

28. The method of claim 23 wherein the window covering products are shutters, venetian blinds, roman shades, cellular shades, pleated shades, rollup shades, roller shades or vertical blinds.

29. The method of claim 23 wherein at least one of the at least one jamb and casement system is comprised of:
a jamb sized and configured to fit within the window opening, the jamb having a first side, an opposite second side, a front face extending between the first side and the second side and a rear face extending between the first side and the second side;
a casement connected to the first side of the jamb; and
an inner covering trim, a portion of the inner covering trim overlaying a portion of the front face of the jamb, the inner covering trim extending beyond the front face of the jamb adjacent the second side of the jamb.

30. The method of claim 29 wherein the jamb and casement system is further comprised of at least one material selected from the group consisting of insulation, foam and filler positioned adjacent the second side of the jamb.

31. The method of claim 29 wherein the jamb and casement system is further comprised of at least one tab attached to the inner covering trim and extending over at least a portion of the second side of the jamb.

32. The method of claim 29 wherein the jamb and casement system is further comprised of at least one resilient member abutting one of the first side of the jamb and the second side of the jamb.

33. The method of claim 32 wherein the at least one resilient member is comprised of a material selected from the group consisting of rubber, plastics and foams.

34. The method of claim 29 wherein the casement has a least one cavity, the jamb and casement system being further comprised of at least one removable cap attached to the casement, the at least one removable cap covering the at least one cavity.

35. The method of claim 29 further comprising a vapor barrier, at least a portion of the vapor barrier being attached to the inner covering trim.

36. The method of claim 23 further comprising advertising the at least one jamb and casement system and the selection of window covering products sized to fit the opening in the jamb and casement system.

37. The method of claim 23 wherein the selected jamb and casement system is delivered separately from the selected window covering product.

38. The method of claim 23 wherein the selected jamb and casement system is packaged with the selected window covering product such that the jamb and casement system is delivered at the same time the window covering product is delivered.

39. The method of claim 23 further comprising installing at least one of the selected at least one jamb and casement system and the selected window covering products in a window opening.
